(19) United States
(12) Patent Application Publication
(10) Pub. No.: US 2026/0327159 A1
(43) Pub. Date: Oct. 22, 2026

(54) METHOD FOR PRODUCING SUPERPHOSPHATE WITH IN SITU FLUORINE SEQUESTRATION

(71) Applicant: PHOSPHOLUTIONS INC., State College, PA (US)

(72) Inventors: Kyle J. ISAACSON, Parrish, FL (US); Pauline WELIKHE, Bellefonte, PA (US); Taylor STREHL, Stillman Valley, IL (US); Aaron WALTZ, Rockford, IL (US); Carlos A. LEÓN Y LEÓN, Bellefonte, PA (US)

(21) Appl. No.: 19/104,578

(22) PCT Filed: Aug. 16, 2023
(86) PCT No.: PCT/US2023/030328

§ 371 Date: Feb. 18, 2025

Related U.S. Application Data
(60) Provisional application No. 63/399,382, filed on Aug. 19, 2022.

(51) Int. Cl. C05B 1/02; C05G 3/00; C05G 5/12

(52) U.S. Cl. CPC C05B 1/02; C05G 3/00; C05G 5/12

(57) ABSTRACT

A method for producing superphosphate granules with in situ fluorine sequestration is disclosed including performing a superphosphate manufacturing process. The superphosphate manufacturing process includes reacting a phosphate source and an acid in a reactor stage to form a reaction mixture, the phosphate source including fluorine, converting the reaction mixture to a product mixture, and granulating the product mixture in a granulation stage to form the superphosphate granules. A metal oxide is introduced into at least one stage of the superphosphate manufacturing process, the metal oxide, the phosphate source, and the acid constituting a net production composition. At least a portion of the fluorine of the phosphate source is bound to the metal oxide during the superphosphate manufacturing process as metal oxide-bound fluorine.

### RELATED APPLICATIONS

This application claims the benefit of and priority to U.S. Provisional Patent Application No. 63/399,382, filed Aug. 19, 2022, entitled “Method for Producing Superphosphate with In Situ Fluorine Sequestration,” which is hereby incorporated by reference in its entirety.

### FIELD OF THE INVENTION

This application is directed to a method for producing superphosphate. In particular, this application is directed to a method for producing superphosphate with in situ fluorine sequestration.

### BACKGROUND OF THE INVENTION

The standard process for superphosphate production was first developed in 1840 and involves the chemical treatment of rock phosphate and results in monocalcium phosphate as the primary product. This process led to superphosphate being referenced as the first chemical fertilizer.

While the intricacies of production vary from location to location, the general production process, known as “run-of-the-pile” or “disintegrated,” involves feeding ground phosphate rock into a combination cone mixer and pug mill system where the phosphate rock is introduced to either concentrated sulfuric (65-75% w/w) or phosphoric acids (40-55% w/w P₂O₅). When treated with sulfuric acid, the resulting material is referred to as ordinary superphosphate, normal superphosphate, or single superphosphate (FIG. 1). When the phosphate rock is treated with phosphoric acid instead, the resulting material is referred to as triple superphosphate (“TSP”) (FIG. 2). The material resides in the reaction vessel for approximately 30 minutes. The reaction with the acid results in the production of a semi-solid material that is placed in a den for several hours to allow the product to cool and allow steaming. The denned material is then often conveyed to a storage location where the material is cured for an additional multi-week period. Following the curing process, the material has hardened adequately for agricultural use. Typically, the cured superphosphate is then fed through a clod breaker and into a rotary drum granulator to create a uniform product. Following granulation, the granules undergo drying and cooling procedures and are then screened to desired size. Both granulated single superphosphate and granulated TSP are common commercial fertilizer products.

Additionally, in another process, known as “slurry-type granulation” the curing process is omitted, and superphosphates are produced via a slurry-type granulation process. This manufacturing method is most common with granulated TSP products, but may also be used to produce single superphospate.

Throughout the entire superphosphate manufacturing process, particulate and gaseous emissions are prevalent, particularly fluorine emissions in the forms of silicon tetrafluoride, hydrogen fluoride, and conglomerate fluorine and phosphate particulate. Fluorinated greenhouse gases include some of the longest-lasting and most potent greenhouse gases emitted from human activities. Due to both health and environmental toxicities, regulatory agencies require monitoring of fluorine emissions during superphosphate manufacturing, and efforts are continually made to reduce the quantity of fluorine emitted per ton of superphosphate produced.

TABLE 1
Emission factors for the Production of Normal Superphosphate according
to Inorganic Chemical Industry: Emission Factors 8.5.1

| | | Emission Factor | |
|---|---|---|---|
| | | Kg/Mg of P₂O₅ | lb/ton of P₂O₅ |
| Emission Point | Pollutant | Produced | Produced |
| Rock Unloading^{a} | Particulate^{b} | 0.28 | 0.56 |
| | PM-10^{c} | 0.15 | 0.29 |
| Rock Feeding^{a} | Particulate^{b} | 0.06 | 0.11 |
| | PM-10^{c} | 0.03 | 0.06 |
| Mixer and Den^{d} | Particulate^{b} | 0.26 | 0.52 |
| | Fluoraide^{b} | 0.10 | 0.2 |
| | PM-10^{c} | 0.22 | 0.44 |
| Curing Building^{ae} | Particulate^{b} | 3.6 | 7.2 |
| | Fluoraide^{b} | 1.9 | 3.8 |
| | PM-10^{c} | 3.0 | 6.1 |

^{a}Factors are for emissions from baghouse with an estimated collection efficiency of 99%
^{b}J. M. Nyers, et al., Source Assessment: Phosphate Fertilizer Industry, EPA-600/2-79-019c, U.S. Environmental Protection Agency, Cinncinnati, OH, May 1979.
^{c}Taken from Aerometric Information Retrieval System (AIRS) Listing for Criteria Air Pollutants
^{d}Factors are for emissions from wet scrubbers with a reported 97% control efficiency
^{e}Uncontrolled

While fluorine is discharged at all stages of the superphosphate manufacturing process, the quantity discharged is uniform throughout (see Table 1). Rock unloading and feeding produces considerable particulate emission, but the greatest amount of gaseous and particulate fluoride emitted is during the superphosphate curing stage. On average, approximately 0.2% of the weight of P₂O₅ produced is emitted as fluorine, meaning that a single ton (2,000 lbs) of P₂O₅ produces about 4 lbs of gaseous fluorine which is vented to the atmosphere. In order to reduce these emissions, superphosphate production and granulation facilities are equipped with advanced scrubber systems; however, relatively high levels of fluorine still enter the atmosphere surrounding phosphate production facilities. It would be desirable in the art to further reduce these emissions while not adversely affecting the efficiency of superphosphate fertilizers in the field.

### BRIEF DESCRIPTION OF THE INVENTION

In one exemplary embodiment, a method for producing superphosphate granules with in situ fluorine sequestration includes performing a superphosphate manufacturing process. The superphosphate manufacturing process includes reacting a phosphate source and an acid in a reactor stage to form a reaction mixture, the phosphate source including fluorine, converting the reaction mixture to a product mixture, and granulating the product mixture in a granulation stage to form the superphosphate granules. A metal oxide is introduced into at least one stage of the superphosphate manufacturing process, the metal oxide, the phosphate source, and the acid constituting a net production composition. At least a portion of the fluorine of the phosphate source is bound to the metal oxide during the superphosphate manufacturing process as metal oxide-bound fluorine.

Further aspects of the subject matter of the present disclosure are provided by the following clauses:

A method for producing superphosphate granules with in situ fluorine sequestration, comprising performing a superphosphate manufacturing process, the superphosphate manufacturing process including reacting a phosphate source and an acid in a reactor stage to form a reaction mixture, the phosphate source including fluorine, converting the reaction mixture to a product mixture, and granulating the product mixture in a granulation stage to form the superphosphate granules, introducing a metal oxide into at least one stage of the superphosphate manufacturing process, the metal oxide, the phosphate source, and the acid constituting a net production composition, and binding at least a portion of the fluorine of the phosphate source to the metal oxide during the superphosphate manufacturing process as metal oxide-bound fluorine.

The method of any preceding clause, wherein the converting the reaction mixture to a product mixture is performed in a den stage between the reactor stage and the granulation stage.

The method of any preceding clause, further including curing the product mixture in a curing stage between the den stage and the granulation stage.

The method of any preceding clause, wherein the den stage includes cooling and steaming the reaction mixture.

The method of any preceding clause, wherein the metal oxide is introduced so as to constitute between about 0.5% to about 50%, by weight, of the net production composition.

The method of any preceding clause, further including a mixing stage in which the phosphate source and the acid are mixed together prior to the reactor stage and wherein the metal oxide is introduced into the mixing stage along with the phosphate source and the acid.

The method of any preceding clause, wherein the mixing stage includes at least one of a cone mixer or a pug mill.

The method of any preceding clause, wherein the metal oxide is introduced into the reactor stage.

The method of any preceding clause, wherein the metal oxide is introduced into the granulation stage.

The method of any preceding clause, wherein the converting the reaction mixture to a product mixture is performed in a den stage between the reactor stage and the granulation stage and the metal oxide is introduced into the den stage.

The method of any preceding clause, further including curing the product mixture in a curing stage between the reactor stage and the granulation stage and the metal oxide is introduced into the curing stage.

The method of any preceding clause, wherein the superphosphate manufacturing process includes at least one scrubber stage and the metal oxide is introduced into the at least one scrubber stage.

The method of any preceding clause, wherein the metal oxide is introduced independently into a plurality of the stages of the superphosphate manufacturing process.

The method of any preceding clause, wherein the superphosphate granules are single superphosphate granules.

The method of any preceding clause, wherein the superphosphate granules are TSP granules.

The method of any preceding clause, wherein the phosphate source is phosphate rock.

The method of any preceding clause, wherein the superphosphate manufacturing process is a slurry-type granulation process.

The method of any preceding clause, wherein the superphosphate manufacturing process is a run-of-the-pile granulation process.

The method of any preceding clause, wherein the fluorine is initially present in the phosphate source as silicon tetrafluoride, hydrogen fluoride, conglomerate fluorine and phosphate particulate, or combinations thereof.

The method of any preceding clause, wherein the metal oxide-bound fluorine is intermixed with the superphosphate granules.

The method of any preceding clause, wherein the metal oxide-bound fluorine includes at least 50% by weight of the fluorine of the phosphate source.

The method of any preceding clause, wherein the superphosphate are coherent dispersible granules including at least one metal oxide domain including the metal oxide and the metal oxide-bound fluorine, and at least one phosphate domain including the superphosphate, wherein the at least one metal oxide domain and the at least one phosphate domain are present in the coherent dispersible granules as distinct domains coherently agglomerated together such that the coherent dispersible granules have an intergranular variability in metal oxide:phosphate weight ratio of ±40% and a coherent dispersible granule crush strength of at least 3 lbf.

The method of any preceding clause, wherein the metal oxide includes at least one metal oxide selected from the group consisting of aluminum oxide, α-alumina, β-alumina, γ-alumina, δ-alumina, bauxite, alumina trihydrate, alumina monohydrate, boehmite, pseudoboehmite, gibbsite, iron oxide, hematite, maghemite, magnetite, goethite, iron hydroxide, calcium oxide, calcium hydroxide, copper oxide, magnesium oxide, manganese oxide, manganese dioxide, nickel oxide, silicon dioxide, and zinc oxide, and combinations thereof.

The method of any preceding clause, wherein the metal oxide includes activated metal oxide.

### BRIEF DESCRIPTION OF THE DRAWINGS

These and other features, aspects, and advantages of the present subject matter will become better understood when the following detailed description is read with reference to the accompanying drawings in which:

FIG. 1 is a flow diagram for a method for a run-of-the-pile method for manufacturing single superphosphate.

FIG. 2 is a flow diagram for a method for manufacturing TSP by slurry-type granulation.

FIG. 3 is a is a graph comparing fluorine concentration in the emission from an initial raw material reactor for TSP and TSP with bauxite, according to an embodiment of the present disclosure.

FIG. 4 is a is a graph comparing fluorine emission rate from an initial raw material reactor for TSP and TSP with bauxite, according to an embodiment of the present disclosure.

FIG. 5 is a is a graph comparing fluorine concentration in the emission from a rotatory granulator for TSP and TSP with bauxite, according to an embodiment of the present disclosure.

FIG. 6 is a is a graph comparing fluorine emission rate from a rotatory granulator for TSP and TSP with bauxite, according to an embodiment of the present disclosure.

### DETAILED DESCRIPTION OF THE INVENTION

Disclosed herein are methods for producing superphosphate with in situ fluorine sequestration. Embodiments of the present disclosure, in contrast to methods lacking one or more of the features disclosure herein, have decreased fluorine emissions, decreased greenhouse gas emissions, increased process efficiency, decreased costs, or combinations thereof.

As used herein, “about” indicates a variance of up to 10% from the value being so modified. All values modified with “about” are also intended to convey the unmodified value as an alternative, so that “about 10 μm,” by way of examples, discloses both a range of 9-11 μm as well as specifically 10 μm.

As used herein, “coherent” dispersible granules are differentiated from “agglomerated” dispersible granules in that “agglomerated” refers to granules formed by mechanically agglomerating at least two types of preformed particles together, whereas “coherent” refers to granules formed by agglomerating one type of preformed particle with a second domain of material which is being simultaneously formed. Structural distinctions between coherent dispersible granules and agglomerated dispersible granules include, but are not limited to, greater granule crush strength, improved resistance to attrition, reduced moisture content, greater hygroscopic stability, less intergranular variability in metal oxide:phosphate weight ratio, greater contact surface area between metal oxide and phosphate domains resulting in tighter adhesion, increased metal oxide surface area, reduced binder incorporation, a greater degree of intermixed domains, or combinations thereof.

In one embodiment, a method for producing superphosphate granules with in situ fluorine sequestration includes performing a superphosphate manufacturing process and introducing a metal oxide into at least one stage of the superphosphate manufacturing process. The superphosphate manufacturing process includes reacting a phosphate source and an acid in a reactor stage to form a reaction mixture. The phosphate source includes fluorine. The reaction mixture is converted to a product mixture, and the product mixture is granulated in a granulation stage to form the superphosphate granules. The metal oxide, the phosphate source, and the acid together constitute a net production composition. At least a portion of the fluorine of the phosphate source is bound to the metal oxide during the superphosphate manufacturing process as metal oxide-bound fluorine. The formation of the metal oxide-bound fluorine represents in situ sequestration of fluorine. The metal oxide-bound fluorine may remain intermixed with the superphosphate granules produced by the superphosphate manufacturing process or may be separated from the superphosphate granules produced by the superphosphate manufacturing process. In one embodiment, wherein the product mixture is formed having a particle size larger than is desired for the superphosphate granules, the granulation stage is an inverted granulation in which the product mixture is at least one of milled or pulverized, followed, optionally, by screening. As used herein, “granulation stage” encompasses both granulation and inverted granulation.

The metal oxide may constitute any suitable proportion of the net production composition, including, but not limited to, between about 0.1% to about 75%, by weight, alternatively between about 0.5% to about 50%, alternatively between about 0.5% to about 10%, alternatively between about 5% to about 15%, alternatively between about 10% to about 20%, alternatively between about 15% to about 25%, alternatively between about 20% to about 30%, alternatively between about 25% to about 35%, alternatively between about 30% to about 40%, alternatively between about 35% to about 45%, alternatively between about 40% to about 50%, or any combination or subrange thereof. In one embodiment, the metal oxide is a powdered metal oxide. The powdered metal oxide may have any suitable particle size, including, but not limited to, minus-30 mesh. In another embodiment, a metal oxide suspension is used having a suspended powder having a particle size of less than 100 μm, alternatively less than 75 μm, alternatively less than 50 μm, alternatively less than 25 μm, alternatively between 1 μm and 50 μm.

In one embodiment, converting the reaction mixture to a product mixture is performed in a den stage between the reactor stage and the granulation stage. In a further embodiment, the product mixture is cured in a curing stage between the den stage and the granulation stage. The den stage may include cooling and steaming the reaction mixture.

In one embodiment, the phosphate source and the acid are mixed together in a mixing stage prior to the reactor stage, and the metal oxide is introduced into the mixing stage along with the phosphate source and the acid. In another embodiment, the phosphate source and the acid are mixed together in the mixing stage prior to the reactor stage, and the metal oxide is introduced into the mixing stage after the phosphate source and the acid. The mixing stage may include a cone mixer, a pug mill, or both.

The metal oxide may be introduced into any stage of the method for producing superphosphate granules, a plurality of stages in any combination, or in all stages, including, but not limited to, the mixing stage, the reactor stage, the den stage, the granulation stage, the curing stage, or the scrubber stage.

The superphosphate granules produced by the superphosphate manufacturing process may be single superphosphate granules or TSP granules.

The phosphorus source used in the phosphate manufacturing process may be any suitable phosphate source, including, but not limited to phosphorus rock, struvite, avian litter, or combinations thereof.

The superphosphate manufacturing process may be a slurry-type granulation process or a run-of-the-pile process. In a further embodiment, the slurry-type granulation process may be used for the production of TSP granules.

The fluorine may be present in the phosphate source in any form, including, but not limited to, silicon tetrafluoride, hydrogen fluoride, conglomerate fluorine and phosphate particulate, or combinations thereof. The method for producing superphosphate granules with in situ fluorine sequestration may sequester any suitable proportion of the fluorine of the phosphate source in the form of metal oxide-bound fluorine, including, but not limited to, at least 25% of the fluorine of the phosphate source, alternatively at least 30% of the fluorine of the phosphate source, alternatively at least 35% of the fluorine of the phosphate source, alternatively at least 40% of the fluorine of the phosphate source, alternatively at least 45% of the fluorine of the phosphate source, alternatively at least 50% of the fluorine of the phosphate source, alternatively at least 55% of the fluorine of the phosphate source, alternatively at least 60% of the fluorine of the phosphate source, alternatively at least 65% of the fluorine of the phosphate source, alternatively at least 70% of the fluorine of the phosphate source, alternatively at least 75% of the fluorine of the phosphate source, alternatively at least 80% of the fluorine of the phosphate source, alternatively at least 85% of the fluorine of the phosphate source, alternatively at least 90% of the fluorine of the phosphate source, alternatively at least 95% of the fluorine of the phosphate source, alternatively at least 98% of the fluorine of the phosphate source, alternatively at least 99% of the fluorine of the phosphate source.

The metal oxide may be any suitable metal oxide, including, but not limited to, aluminum oxide, α-alumina, β-alumina, γ-alumina, δ-alumina, bauxite, alumina trihydrate, alumina monohydrate, boehmite, pseudoboehmite, gibbsite, iron oxide, hematite, maghemite, magnetite, goethite, iron hydroxide, calcium oxide, calcium hydroxide, copper oxide, magnesium oxide, manganese oxide, manganese dioxide, nickel oxide, silicon dioxide, and zinc oxide, and activated metal oxide form of any of the foregoing, or combinations thereof. The metal oxide may be activated via calcination, acid treatment, or combinations thereof. As used herein, “metal oxide” is understood to be inclusive of metal oxide hydrates and metal oxide hydroxides.

The superphosphate granules may be agglomerated dispersible granules or coherent dispersible granules. The coherent dispersible granules may have a greater coherent dispersible granule crush strength than the agglomerated dispersible granules. In one embodiment, the coherent dispersible granules have a coherent dispersible granule crush strength of at least 3 lbf, alternatively at least 3.5 lbf, alternatively at least 4 lbf, alternatively at least 4.5 lbf, alternatively at least 5 lbf.

In one embodiment, the superphosphate granules are coherent dispersible granules including at least one metal oxide domain including the metal oxide and the metal oxide-bound fluorine, and at least one phosphate domain including the superphosphate, wherein the at least one metal oxide domain and the at least one phosphate domain are present in the coherent dispersible granules as distinct domains coherently agglomerated together such that the coherent dispersible granules have an intergranular variability in metal oxide:phosphate weight ratio of ±40% and a coherent dispersible granule crush strength of at least 3 lbf.

The at least one metal oxide domain and the at least one phosphate domain may be intragranularly homogenously or heterogeneously distributed in the superphosphate granules. The at least one metal oxide domain and the at least one phosphate domain of the soil regulation dispersible granules may be intergranularly homogenously or heterogeneously distributed in the superphosphate granules.

In one embodiment, each of the at least one metal oxide domain is at least 50% surrounded by the at least one phosphate domain, alternatively at least 60% surrounded, alternatively at least 70% surrounded, alternatively at least 80% surrounded, alternatively at least 90% surrounded, alternatively at least 95% surrounded, alternatively at least 99% surrounded, alternatively entirely surrounded.

The superphosphate granules may include at least one of a water-soluble binder, a suspension agent, or an emulsifying agent. In one embodiment, the superphosphate granules include, by weight, 1-40% water-soluble binder, alternatively 5-35%, alternatively 5-15%, alternatively 10-20%, alternatively 15-25%, alternatively 20-30%, alternatively 25-35%, or any sub-range or combination thereof. Suitable water-soluble binders include, but are not limited to, calcium lignosulfonate, ammonium lignosulfonate, or combinations thereof. Suitable suspension agents include, but are not limited to, polysaccharides, inorganic salts, carbomers, or combinations thereof. Suitable emulsifying agents include, but are not limited to, vegetable derivatives such as acacia, tragacanth, agar, pectin, carrageenan, or lecithin, animal derivatives such as gelatin, lanolin, or cholesterol, semi-synthetic agents such as methylcellulose, or carboxymethylcellulose, synthetics such as benzalkonium chloride, benzethonium chloride, alkali soaps (including sodium or potassium oleate), amine soaps (including triethanolamine stearate), detergents (including sodium lauryl sulfate, sodium dioctyl sulfosuccinate, or sodium docusate), sorbitan esters, polyoxyethylene derivatives of sorbitan esters, glyceryl esters, or combinations thereof.

In one embodiment, the superphosphate granules include by weight, 1-60% metal oxide domain, 30-95% phosphate domain, and, optionally, 0-50% water-soluble binder, alternatively 30-40% metal oxide domain, 30-40% phosphate domain, and 20-40% water-soluble binder, alternatively 35% metal oxide domain, 35% phosphate domain, and 30% water-soluble binder, or any sub-ranges or combinations thereof. In a further embodiment, the superphosphate granules include by weight, 5-70% metal oxide domain, 10-70% phosphate domain, up to 50% water-soluble binder, and up to 20% surfactants and emulsifiers combined, alternatively consist of, by weight, 5-50% metal oxide domain, 10-50% phosphate domain, up to 50% water-soluble binder, and up to 5% surfactants and emulsifiers combined.

The superphosphate granules may have any suitable size (as measured by diameter based upon the median within the sample). Suitable sizing for the superphosphate granules may include, but is not limited to, about 0.4 mm to about 4.0 mm, alternatively about 0.4 mm to about 1.2 mm, alternatively about 0.9 mm to about 1.5 mm, alternatively about 1.2 mm to about 1.8 mm, alternatively about 1.5 mm to about 2.1 mm, alternatively about 1.8 mm to about 2.4 mm, alternatively about 2.1 mm to about 2.7 mm, alternatively about 2.4 mm to about 3.0 mm, alternatively about 2.7 mm to about 3.3 mm, alternatively about 3.0 mm to about 3.6 mm, alternatively about 3.3 mm to about 4.0 mm, alternatively about 0.4 mm, alternatively about 0.5 mm, alternatively about 0.6 mm, alternatively about 0.7 mm, alternatively about 0.8 mm, alternatively about 0.9 mm, alternatively about 1.0 mm, alternatively about 1.1 mm, alternatively about 1.2 mm, alternatively about 1.3 mm, alternatively about 1.4 mm, alternatively about 1.5 mm, alternatively about 1.6 mm, alternatively about 1.7 mm, alternatively about 1.8 mm, alternatively about 1.9 mm, alternatively about 2.0 mm, alternatively about 2.1 mm, alternatively about 2.2 mm, alternatively about 2.3 mm, alternatively about 2.4 mm, alternatively about 2.5 mm, alternatively about 2.6 mm, alternatively about 2.7 mm, alternatively about 2.8 mm, alternatively about 2.9 mm, alternatively about 3.0 mm, alternatively about 3.1 mm, alternatively about 3.2 mm, alternatively about 3.3 mm, alternatively about 3.4 mm, alternatively about 3.5 mm, alternatively about 3.6 mm, alternatively about 3.7 mm, alternatively about 3.8 mm, alternatively about 3.9 mm, alternatively about 4.0 mm, alternatively more than about 4.0 mm, or any sub-range or combination thereof. In one non-limiting example, golf greens may use superphosphate granules of about 0.5 mm to about 0.8 mm. In another non-limiting example, corn may use superphosphate granules via a broadcast application of about 2.4 mm. In a third non-limiting example, any crop with a strip-till machine application may use superphosphate granules of about 1.5 mm. In one embodiment, suitable, for example, for application as a suspension, the superphosphate granules are micronized, and have a particle size less than about 200 μm, alternatively less than about 150 μm, alternatively less than about 100 μm, alternatively less than about 75 μm, alternatively less than about 1 μm, alternatively less than about 1 μm, alternatively less than about 50 μm, alternatively less than about 25 μm, alternatively less than about 10 μm, alternatively less than about 5 μm, alternatively less than about 2 μm, alternatively less than about 1 μm, alternatively less than about 0.75 μm, alternatively less than about 0.5 μm, alternatively less than about 0.25 μm, alternatively less than about 0.1 μm, alternatively less than about 0.05 μm, alternatively less than about 0.01 μm, as measured by largest particle dimension.

The weight ratio of metal oxide:phosphate in the superphosphate granules may be any suitable weight ratio, including but not limited to, a weight ratio of 20:1 to 1:20, alternatively 10:1 to 1:10. alternatively 8:1 to 1:8, alternatively 7:1 to 1:7, alternatively 6:1 to 1:6, alternatively 5:1 to 1:5, alternatively 4:1 to 1:4, alternatively 3:1 to 1:3, alternatively 2:1 to 1:2, alternatively 3:1 to 1:1, alternatively 1:1 to 1:3, alternative about 2:1, alternatively about 1:1, alternatively about 1:2, or any sub-range or combination of ranges thereof.

### Examples

### Methods

A study was conducted in which granulated TSP was produced on a large-scale pilot plant via slurry-type granulation at the International Fertilizer Development Center (“IFDC”). First, TSP was produced under standard procedures. Next, bauxite was added into the process. In both cases, fluorine emissions were monitored at two locations within the plant. The process is detailed below.

### Superphosphate Production

Phosphate rock was fed into a reactor using an ACCURATE® solids feeder. Antifoam solution was fed into the reactor using a peristaltic pump. Bauxite, when used, was fed into the reactor using a second ACCURATE® solids feeder. The flow rates of phosphate rock, antifoam, and bauxite were manually checked every 30 minutes using a scale and stopwatch. The merchant-grade phosphoric acid (“MGA”) used was stored in two 4,150 L stainless steel cone-bottomed storage tanks. The MGA in the storage tanks was recirculated using a centrifugal pump to keep the insoluble solids in suspension. The MGA used to produce TSP was transferred from the storage tanks to a 1,300 L stainless steel feed tank. The MGA in the feed tank was recirculated to prevent the solids from settling. A centrifugal pump was used to transfer the MGA from the feed tank into the reactor. The MGA flow rate was measured by using a magnetic flow meter and was manually checked and confirmed every 30 minutes using a scale and stopwatch.

The reactor utilized was 61 cm in diameter and 201 cm high, with a 9 cm shallow cone bottom. A constant level was maintained in the reactor by using an overflow opening located 74 cm above the cone. The reactor is equipped with a variable speed agitator fitted with three axial-flow thrust turbines. The slurry overflowed into the pump surge tank, from which it was transferred to the drum granulator using a progressive-cavity variable speed pump. The pump speed was varied to maintain a constant level in the surge tank. The reactor slurry spray discharged into the granulator through a drilled pipe onto the rolling bed of material.

An exhaust fan was used to force the reactor gases through a spray-type scrubber to clean the gases before exhausting them into the atmosphere. Water was used as the scrubbing medium. The exhaust fan and the scrubber system were coated with fluorine-resistant reinforced polyester.

The large-scale pilot plant granulator was 92 cm in diameter and 180 cm long. A 15 cm retaining dam was located 25.4 cm from the discharge end of the granulator. The granulator was operated at a 1.5-degree angle of inclination from horizontal toward the discharge.

Gases drawn from the granulator were treated in a once-through venturi-type scrubber. The scrubbing system used water as the scrubbing medium. The scrubbing system consisted of a reinforced polyester venturi-type scrubber, a reinforced polyester recirculation seal tank, a centrifugal recirculating pump, and a carbon steel fan. The scrubber liquor was not returned to the process but was drained to an onsite effluent retention pond.

From the granulator, the moist granular material was discharged by gravity into a rotary drum-type dryer. The dryer was 92 cm in diameter and 7.3 m long. The dryer was operated with co-current airflow heated by a natural gas-fired burner in a combustion chamber located at the inlet (material feed end) of the dryer. The operating temperature of the dryer was controlled indirectly by measuring the temperature of the dryer discharge material and adjusting the air-to-gas ratio of the combustion chamber to maintain the desired operating temperature. The dryer was operated at a 2.0-degree angle of inclination from horizontal toward the discharge. The dryer was equipped with a band of four hammers, with each hammer weighing 7.7 kilograms (kg).

A cyclone-type dust collector was located in the process air duct between the dryer discharge and the dryer fan. The dryer cyclone dust collector was rated at 6,797 actual cubic meters per hour (Am³/h). The dryer fan exhaust duct was connected to a DynaWave scrubber.

Dust collected in the dryer cyclone was not returned to the process; it was weighed before being disposed. Gases drawn from the dryer, after passing through the dryer cyclone, were treated in a wet scrubber before being exhausted into the atmosphere. The scrubbing system used water as the scrubbing media and consists of a 316 L stainless steel fan. Airflow through the dryer ranged from 3,600 to 3,800 m³/hr. The resulting scrubber liquor was not returned to the process but was sent to an effluent pond.

A centrifugal bucket elevator was used to transfer the material from the dryer to an inclined double-deck, mechanically vibrated screening system. The screen housing was fitted with a Ty-Rod 4.00 mm oversize screen and Ty-Rod 2.36 mm undersize screen to yield a product in the 2.36 to 4.00 mm size range. Oversize material from the screening system was routed to a chain mill. The crushed material discharging from the chain mill was returned to the screening system. Undersize material from the screening system was returned (recycled) to the granulator together with a controlled fraction of the product-size material, when necessary, to maintain granulation control. The product-size fraction from the screening system was transferred to a product cooler that was operated with co-current airflow vented to the fugitive dust collection system. The product cooler was operated at a rotational speed of 10 rpm. From the product cooler, the product-size material was discharged into 1 metric ton bags.

The pilot plant was equipped with a fugitive dust collection system. This system included a network of pickup ducts connected to a cyclone-type dust collector. The dust collector received the dust from the elevators, screening system, and conveyors. The fugitive dust cyclone was rated at 6,797 Am³/h. A 316 L stainless steel centrifugal fan exhausted the air into the atmosphere.

All process equipment in the large-scale granulation pilot plant was constructed from mild steel with the exception of the venturi-type scrubber, reactor, auxiliary tanks, dryer elevator, and DynaWave scrubber. The mild steel components were coated on the outside with a zinc-epoxy corrosion-resistant resin. The interior of the equipment was not coated.

Composite samples of the product from each test were taken and evaluated in IFDC laboratories to determine the chemical composition and selected physical properties. Samples from other selected process streams were also taken during each test and submitted to IFDC laboratories for chemical analyses.

IFDC subcontracted with Alliance Technical Group to monitor selected airstreams for fluorine content. The airstreams monitored were the reactor and granulator outlets. In both production runs (TSP and TSP with bauxite), the system was run for adequate time quantities to reach a steady state and provide reliable data. The methods for fluorine emission evaluation are detailed below.

### Fluorine Emissions Monitoring

The emission testing program was conducted in accordance with the test methods listed in Table 2. Method descriptions are provided below.

TABLE 2
Source Testing Methodology

| | U.S. EPA Reference | |
|---|---|---|
| Parameter | Test Methods | Notes/Remarks |
| Volumetric Flow Rate | 1 & 2 | Full Velocity Traverses |
| Moisture Content | 4 | Gravimetric Analysis |
| Fluorine | 13B | Isokinetic Sampling |

### U.S. EPA Reference Test Methods 1 and 2—Volumetric Flow Rate

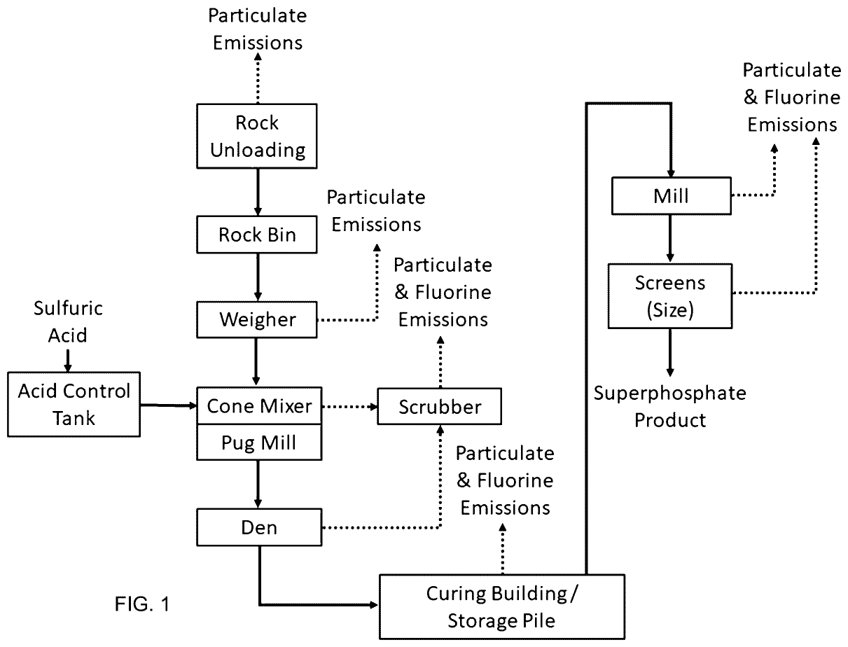

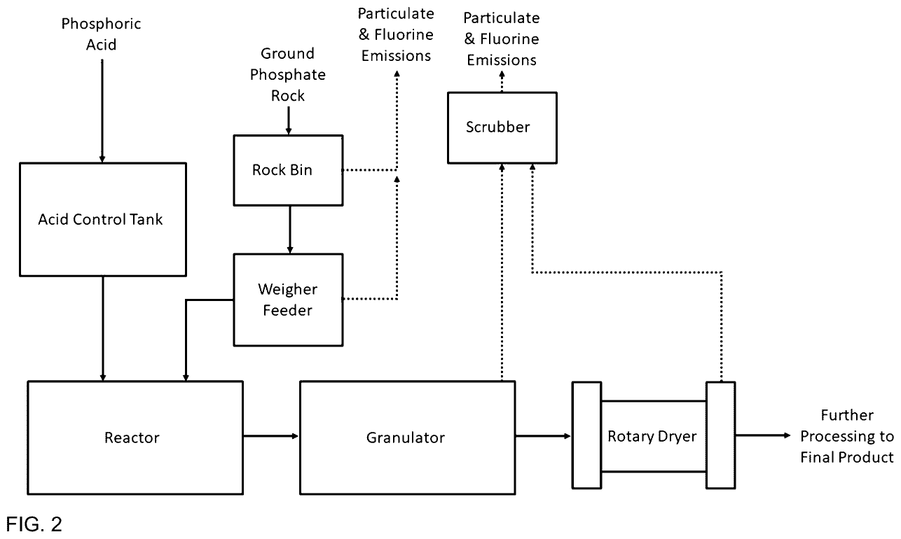

The sampling location and number of traverse (sampling) points were selected in accordance with U.S. EPA Reference Test Method 1. To determine the minimum number of traverse points, the upstream and downstream distances were equated into equivalent diameters and compared to FIG. 1-1 in U.S. EPA Reference Test Method 1.

Full velocity traverses were conducted in accordance with U.S. EPA Reference Test Method 2 to determine the average stack gas velocity pressure, static pressure, and temperature. The velocity and static pressure measurement system included a pitot tube and inclined manometer. The stack gas temperature was measured with a K-type thermocouple and pyrometer.

The O₂ and CO₂ concentration were assumed to be ambient for molecular weight and volumetric flow rate calculations.

Stack gas velocity pressure and temperature readings were recorded during each test run. The data collected was utilized to calculate the volumetric flow rate in accordance with U.S. EPA Reference Test Method 2.

### U.S. EPA Reference Test Method 4—Moisture Content

The stack gas moisture content (“BWS”) was determined in accordance with U.S. EPA Reference Test Method 4. The gas conditioning train consisted of a series of chilled impingers. Prior to testing, each impinger was filled with a known quantity of water or silica gel. Each impinger was analyzed gravimetrically before and after each test run on the same balance to determine the amount of moisture condensed.

### U.S. EPA Reference Test Method 13B—Fluorine

The total fluorides (“TF”) testing was conducted in accordance with U.S. EPA Reference Test Method 13B. The sampling train included a Teflon nozzle, heated stainless steel-lined, quartz filter, gas conditioning train, pump, and calibrated dry gas meter. The gas conditioning train included four chilled impingers. The first two impingers contained 100 mL of de-ionized (“DI”) water, the third was empty, and the fourth contained 200-300 g silica gel. The probe liner heating system was maintained at 120° C.±14° C., and the impinger temperature was maintained at 20° C. or less throughout testing.

Following the completion of each test run, the sampling train was leak checked at vacuum pressure greater than or equal to the highest vacuum pressure observed during the run and the contents of the impingers were measured for moisture gain. The contents of impingers 1-3 were collected in sample container 1. The filter was removed and placed in sample container 1. The nozzle, probe liner, impingers 1-3 and all connecting glassware were rinsed with DI water. These rinses were added to sample container 1. All containers were sealed, labeled, and liquid levels marked for transport to the identified laboratory for analysis.

### Results

TABLE 2
Chemical Analyses of Raw Materials

| Chemical Analysis | Phosphoric Acid | Phosphate Rock | Bauxite |
|---|---|---|---|
| Total P₂O₅ | 52.4 | 31.1 | — |
| Total Sulfur | 3.1 | 2.3 | — |
| CaO | 0.0 | 45.0 | — |
| Fluoride | — | 3.2 | — |
| Al₂O₃ | 0.5 | 1.0 | 44.1 |
| Fe₂O₃ | 0.6 | 0.6 | — |
| K₂O | 0.2 | 0.3 | — |
| MgO | 1.1 | 0.7 | — |
| Na₂O | 0.1 | 0.5 | — |
| CO₂ | — | 3.3 | — |
| H₂O | — | 0.6 | 1.2 |

*Chemical analyses performed according to the AOAC International methods except total nitrogen and sulfur, which were determined using a combustion analyzer.
*“—” indicated not analyzed.

TABLE 3
Summary of General Manufacturing Parameters During
the Production of Granular Triple Superphosphate and
Granular Triple Superphosphate Containing Bauxite.

| | | TSP with |
|---|---|---|
| Condition | TSP | Bauxite |
| Reactor | | |
| Slurry Temperature (°C) | 46 | 64 |
| Slurry Density (g/cm³) | 1.57 | 1.57 |
| Slurry Viscosity (cP) | 332 | 665 |
| Drum Granulator | | |
| Bed Temperature (°C) | 51 | 49 |
| Recycle Temperature (°C) | 60 | 59 |
| Recycle-to-Product Ratio (kg:kg) | 17.8 | 17.7 |
| Rotational Speed (rpm) | 20 | 20 |
| Rotary Dryer | | |
| Rotational Speed (rpm) | 12 | 12 |
| Air Inlet Temperature (°C) | 264 | 241 |
| Natural Gas Usage (kg/h) | 6.6 | 7.0 |
| Material Discharge Temperature (°C) | 70 | 69 |
| Air Outlet Temperature (°C) | 55 | 56 |
| Ambient Conditions | | |
| Relative Humidity (min/max) (%) | 67 / 81 | 65 / 66 |
| Temperature (min/max) (°C) | 28 / 31 | 30 / 31 |

* Viscosity was determined using Brookfield Ametek Dial Reading Viscometer, Model LVT.

Referring to Table 3, despite the addition of a solid powder material, the manufacturing conditions were not dramatically altered. The similar recycle ratios between the two runs indicate that there was no considerable difference in manufacturing efficiency following the addition of bauxite.

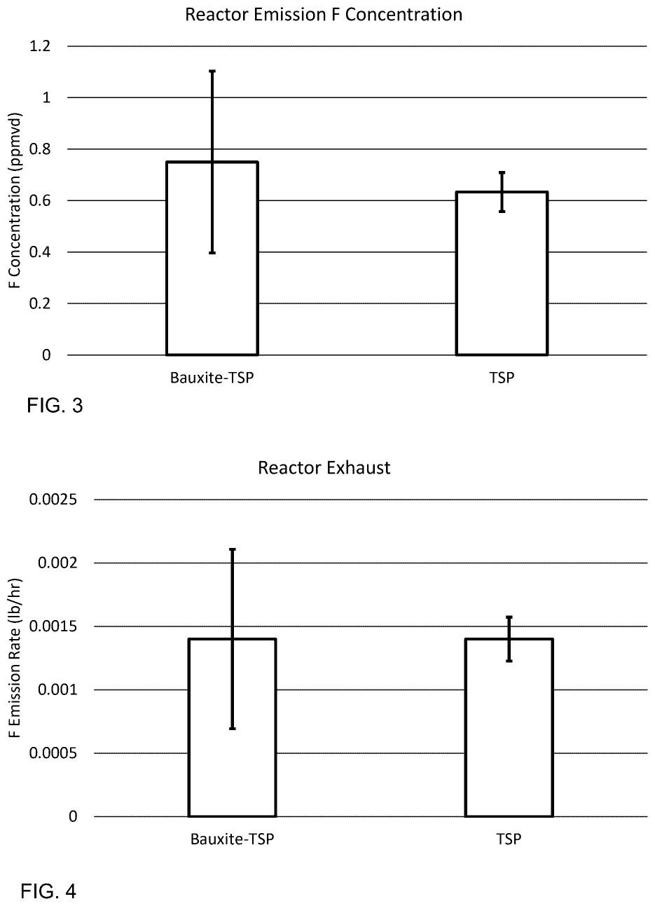

Referring to FIG. 3, fluorine concentrations in the emissions coming from the initial raw material reactor is presented. No statistical difference between the two runs was observed, despite the solution within the reactor being higher during the Bauxite-TSP run than the TSP run. This lack of difference between the two runs was expected, as the phosphoric acid must first dissolve the phosphate rock within this reactor to release gaseous fluorine. Since the bauxite did not have adequate time to react with the fluorine in this environment, it was expected that no statistical difference would be observed. The lack of statistical difference evidences that emission readings and fluorine concentration analyses were accurate during testing.

Referring to FIG. 4, fluorine emission rates coming from the initial raw material reactor for both TSP and TSP with bauxite manufacturing runs is presented. No statistical difference between the two runs was observed, despite the solution within the reactor being higher during the Bauxite-TSP run than the TSP run. The overall emission volume was lower during the Bauxite-TSP run than during the TSP run, leading to the change between FIG. 3 and FIG. 4. This lack of difference between the two runs indicates was expected, as the phosphoric acid must first dissolve the phosphate rock within this reactor to release gaseous fluorine. Since the bauxite did not have adequate time to react with the fluorine in this environment, it was expected that no statistical difference would be observed. The lack of statistical difference evidences that emission readings and fluorine concentration analyses were accurate during testing.

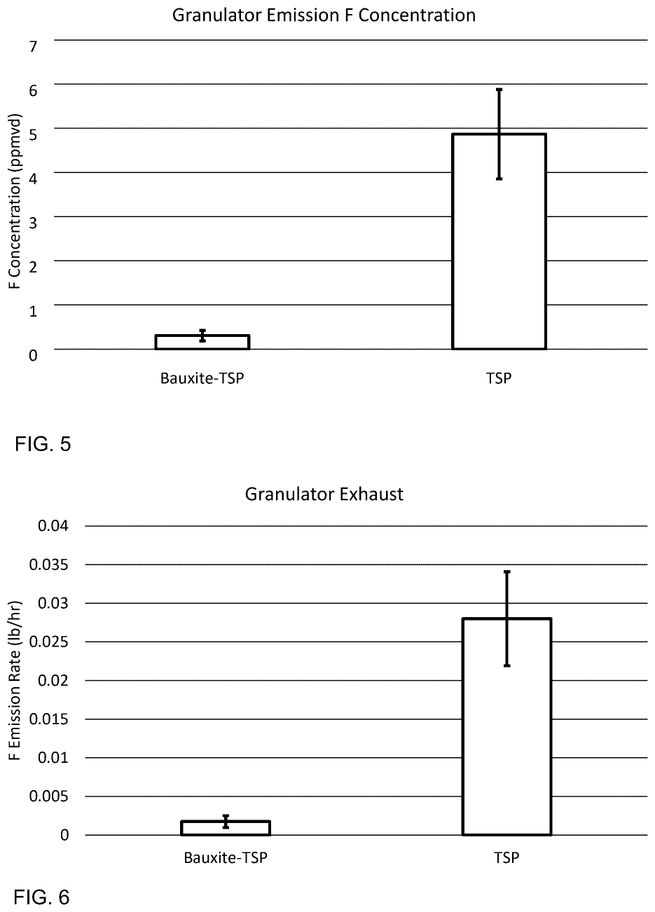

Referring to FIG. 5, fluorine concentrations in the emissions coming from the rotary granulator are presented. A strong statistical difference between the two runs was observed, despite only minor alterations to manufacturing and granulator conditions. Overall, a 94% reduction in fluorine concentration in the emissions was observed in the Bauxite-TSP run compared to the TSP run. The difference between the two runs was unexpected, as it indicates that the bauxite was actively sequestering gaseous fluorine as it was being produced via acidic dissolution of the phosphate rock during the manufacturing process.

Referring to FIG. 6, fluorine emission rates coming from the rotary granulator during the TSP and TSP with bauxite manufacturing runs is presented. A strong statistical difference between the two runs was observed, despite only minor alterations to manufacturing and granulator conditions. Overall, a 94% reduction in fluorine emissions was observed in the Bauxite-TSP run compared to the TSP run. The overall emissions volume was identical between the two runs. The difference in fluorine emissions between the two runs was unexpected, as it indicates that the bauxite was actively sequestering gaseous fluorine as it was being produced via acidic dissolution of the phosphate rock during the manufacturing process.

TABLE 4
Physical Characteristics of the Granules Produced During
Both TSP and TSP with Bauxite Granulation Runs.

| | | TSP with |
|---|---|---|
| Test Identification | TSP | Bauxite |
| Size Analysis (Cumulative | | |
| Percentage Retained on Screen) | | |
| 4.00 mm | 13.8 | 4.6 |
| 3.35 mm | 50.6 | 36.4 |
| 2.80 mm | 76.9 | 63.0 |
| 2.36 mm | 92.6 | 82.2 |
| 2.00 mm | 98.7 | 92.5 |
| 1.70 mm | 99.7 | 96.3 |
| Size Guide Number (“SGN”) | 401 | 367 |
| Uniformity Index (“U.I.”) | 53 | 47 |
| Granule Crush Strength (kgf/granule) | 3.08 | 2.85 |
| Abrasion Resistance (% Degradation) | 0.15 | 0.48 |
| Impact Resistance (% Shattered) | 15.32 | 13.33 |

Referring to Table 4, despite the addition of bauxite, no detrimental effects in granule quality were observed.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for producing superphosphate granules with in situ fluorine sequestration, comprising:
performing a superphosphate manufacturing process, the superphosphate manufacturing process including:
reacting a phosphate source and an acid in a reactor stage to form a reaction mixture, the phosphate source including fluorine;
converting the reaction mixture to a product mixture; and
granulating the product mixture in a granulation stage to form the superphosphate granules;
introducing a metal oxide into at least one stage of the superphosphate manufacturing process, the metal oxide, the phosphate source, and the acid constituting a net production composition; and
binding at least a portion of the fluorine of the phosphate source to the metal oxide during the superphosphate manufacturing process as metal oxide-bound fluorine.

2. The method of claim 1, wherein the converting the reaction mixture to a product mixture is performed in a den stage between the reactor stage and the granulation stage.

3. The method of claim 2, further including curing the product mixture in a curing stage between the den stage and the granulation stage.

4. The method of claim 2, wherein the den stage includes cooling and steaming the reaction mixture.

5. The method of claim 1, wherein the metal oxide is introduced so as to constitute between about 0.5% to about 50%, by weight, of the net production composition.

6. The method of claim 1, further including a mixing stage in which the phosphate source and the acid are mixed together prior to the reactor stage and wherein the metal oxide is introduced into the mixing stage along with the phosphate source and the acid.

7. The method of claim 6, wherein the mixing stage includes at least one of a cone mixer or a pug mill.

8. The method of claim 1, wherein the metal oxide is introduced into the reactor stage.

9. The method of claim 1, wherein the metal oxide is introduced into the granulation stage.

10. The method of claim 1, wherein the converting the reaction mixture to a product mixture is performed in a den stage between the reactor stage and the granulation stage and the metal oxide is introduced into the den stage.

11. The method of claim 1, further including curing the product mixture in a curing stage between the reactor stage and the granulation stage and the metal oxide is introduced into the curing stage.

12. The method of claim 1, wherein the superphosphate manufacturing process includes at least one scrubber stage and the metal oxide is introduced into the at least one scrubber stage.

13. The method of claim 1, wherein the metal oxide is introduced independently into a plurality of the stages of the superphosphate manufacturing process.

14. The method of claim 1, wherein the superphosphate granules are single superphosphate granules.

15. The method of claim 1, wherein the superphosphate granules are triple superphosphate granules.

16. The method of claim 1, wherein the phosphate source is phosphate rock.

17. The method of claim 1, wherein the superphosphate manufacturing process is a slurry-type granulation process.

18. The method of claim 1, wherein the superphosphate manufacturing process is a run-of-the-pile granulation process.

19. The method of claim 1, wherein the fluorine is initially present in the phosphate source as silicon tetrafluoride, hydrogen fluoride, conglomerate fluorine and phosphate particulate, or combinations thereof.

20. The method of claim 1, wherein the metal oxide-bound fluorine is intermixed with the superphosphate granules.

21. The method of claim 1, wherein the metal oxide-bound fluorine includes at least 50% by weight of the fluorine of the phosphate source.

22. The method of claim 1, wherein the superphosphate are coherent dispersible granules including:
at least one metal oxide domain including the metal oxide and the metal oxide-bound fluorine; and
at least one phosphate domain including the superphosphate,
wherein the at least one metal oxide domain and the at least one phosphate domain are present in the coherent dispersible granules as distinct domains coherently agglomerated together such that the coherent dispersible granules have an intergranular variability in metal oxide:phosphate weight ratio of ±40% and a coherent dispersible granule crush strength of at least 3 lbf.

23. The method of claim 1, wherein the metal oxide includes at least one metal oxide selected from the group consisting of aluminum oxide, α-alumina, β-alumina, γ-alumina, δ-alumina, bauxite, alumina trihydrate, alumina monohydrate, boehmite, pseudoboehmite, gibbsite, iron oxide, hematite, maghemite, magnetite, goethite, iron hydroxide, calcium oxide, calcium hydroxide, copper oxide, magnesium oxide, manganese oxide, manganese dioxide, nickel oxide, silicon dioxide, and zinc oxide, and combinations thereof.

24. The method of claim 1, wherein the metal oxide includes activated metal oxide.
